(19) United States
(12) Patent Application Publication
(10) Pub. No.: US 2023/0256332 A1
(43) Pub. Date: Aug. 17, 2023

(54) MASSIVELY MULTIPLAYER LOCAL CO-OP AND COMPETITIVE GAMING

(71) Applicant: Sony Interactive Entertainment Inc., Tokyo (JP)

(72) Inventors: Warren Benedetto, San Mateo, CA (US); Landon Noss, San Mateo, CA (US)

(21) Appl. No.: 17/673,096

(22) Filed: Feb. 16, 2022

(51) Int. Cl. A63F 13/27; A63F 13/235; A63F 13/327; A63F 13/212; A63F 13/847

(52) U.S. Cl. CPC A63F 13/27; A63F 13/235; A63F 13/327; A63F 13/212; A63F 13/847; A63F 2300/8023; A63F 2300/8082

(57) ABSTRACT

A technique for scaling a multiplayer co-op and competitive computer gaming to dozens or even scores of people playing simultaneously, for example in a movie theater. The gameplay occurs on the giant screen at the front of the theater. Each person has a controller to control one character or avatar in a gameplay space that is projected on the screen. In a theater with one hundred people in the seats, for example, one hundred respective avatars can appear on the screen, each controlled by a respective different player.

### FIELD

The present application relates generally to massively multiplayer local co-op computer gaming and competitive computer gaming.

### BACKGROUND

As recognized herein, local multiplayer cooperative (co-op) and competitive gaming is usually done with two to four players in a room together. Each player has a controller used by the player to control a character on screen. These experiences are built for a limited number of people playing on a single console, usually in a home.

### SUMMARY

As recognized herein, an opportunity exists to build local multiplayer experiences in large venues such as movie theaters which allow dozens or scores of people to play simultaneously. Doing this requires novel approaches to managing large numbers of inputs to a single game instance. There is also an opportunity to build local multiplayer games in AR, which also introduces novel challenges of rendering many slightly-different points of view of the same game.

Accordingly, an assembly includes plural computer simulation controllers, each associated with a respective seat in a theater, and each correlated to a respective game object in the simulation. The assembly also includes at least one display in the theater configured to present the computer simulation in accordance with signals sent from the plural computer simulation controllers.

In one implementation, each computer simulation controller is associated with one and only one respective game object.

In an embodiment, the at least one display includes a theater screen visible to people sitting in the seats. In some implementations of this embodiment, at least one server communicates with the computer simulation controllers over a wide area computer network and is configured for sending audio video content representing the computer simulation to the at least one display. In other implementations of this embodiment, plural wireless short-range transceivers are provided with each being configured for communicating with a respective subset of the computer simulation controllers such that a first wireless short-range transceiver can communicate with a first subset of the computer simulation controllers and a second wireless short-range transceiver can communicate with a second subset of the computer simulation controllers. At least one server is local to the display and receives signals from the computer simulation controllers through the plural wireless short-range transceivers. The server is configured for sending audio video content representing the computer simulation to the at least one display. In still other implementations of this embodiment, at least one server is local to the at least one display and is connected to the computer simulation controllers by wired paths for sending audio video content representing the computer simulation to the at least one display.

In another embodiment the at least one display includes plural head-mounted displays (HMD), with each HMD being associated with a respective seat. In this embodiment plural computer simulation computers (CSC) may be provided with each being associated with a respective HMD and a respective computer simulation controller. When provided, the CSCs are configured for receiving signals from the respective computer simulation controllers for presenting on the respective HMDs the computer simulation consistent with the signals from the computer simulation controllers. The CSCs communicate simulation object control signals to each other, and each CSC is configured for presenting an instance of the computer simulation on the respective HMD identical to other instances of the computer simulation presented on other HMDs but for each instance being presented from a perspective of the respective seat.

In some examples, at least one processor is programmed with instructions to present on the at least one display at least one user interface (UI) including UI elements for correlating a respective simulation controller with a respective simulation object.

In another aspect, a method includes presenting a computer game on at least one display in a theater and controlling the computer game using signals from plural game controllers each associated with a respective seat in the theater.

In another aspect, a system includes at least one processor and at least one display. Plural computer simulation controllers are also provided, each being associated with a respective seat in a theater and configured for sending signals to the processor to control a computer simulation on the display.

The details of the present application, both as to its structure and operation, can be best understood in reference to the accompanying drawings, in which like reference numerals refer to like parts, and in which:

### BRIEF DESCRIPTION OF THE DRAWINGS

FIG. 1 is a block diagram of an example system in accordance with present principles perspective view of an example headset;

FIG. 2 illustrates an example theater seat;

FIG. 3 illustrates an example massively multiplayer local co-op and competitive gaming environment;

FIG. 4 illustrates a first implementation of a multiplayer local co-op and competitive gaming environment such as that shown in FIG. 3;

FIG. 5 illustrates a second implementation of a multiplayer local co-op and competitive gaming environment such as that shown in FIG. 3;

FIG. 6 illustrates a third implementation of a multiplayer local co-op and competitive gaming environment such as that shown in FIG. 3;

FIG. 7 illustrates a fourth implementation of a multiplayer local co-op and competitive gaming environment;

FIGS. 8-11 illustrate example logic in example flow chart format associated with the techniques in FIGS. 4-7, respectively; and

FIG. 12 illustrates an example user interface (UI) that may be presented on the theater screen or on each HMD as appropriate to associate game objects with seats by means of associating game objects to the IDs of the respective controllers of each seat.

### DETAILED DESCRIPTION

This disclosure relates generally to computer ecosystems including aspects of consumer electronics (CE) device networks such as but not limited to computer game networks. A system herein may include server and client components which may be connected over a network such that data may be exchanged between the client and server components. The client components may include one or more computing devices including game consoles such as Sony PlayStation® or a game console made by Microsoft or Nintendo or other manufacturer, virtual reality (VR) headsets, augmented reality (AR) headsets, portable televisions (e.g., smart TVs, Internet-enabled TVs), portable computers such as laptops and tablet computers, and other mobile devices including smart phones and additional examples discussed below. These client devices may operate with a variety of operating environments. For example, some of the client computers may employ, as examples, Linux operating systems, operating systems from Microsoft, or a Unix operating system, or operating systems produced by Apple, Inc., or Google, or a Berkeley Software Distribution or Berkeley Standard Distribution (BSD) OS including descendants of BSD. These operating environments may be used to execute one or more browsing programs, such as a browser made by Microsoft or Google or Mozilla or other browser program that can access websites hosted by the Internet servers discussed below. Also, an operating environment according to present principles may be used to execute one or more computer game programs.

Servers and/or gateways may be used that may include one or more processors executing instructions that configure the servers to receive and transmit data over a network such as the Internet. Or a client and server can be connected over a local intranet or a virtual private network. A server or controller may be instantiated by a game console such as a Sony Play Station®, a personal computer, etc.

Information may be exchanged over a network between the clients and servers. To this end and for security, servers and/or clients can include firewalls, load balancers, temporary storages, and proxies, and other network infrastructure for reliability and security. One or more servers may form an apparatus that implement methods of providing a secure community such as an online social website or gamer network to network members.

A processor may be a single- or multi-chip processor that can execute logic by means of various lines such as address lines, data lines, and control lines and registers and shift registers.

Components included in one embodiment can be used in other embodiments in any appropriate combination. For example, any of the various components described herein and/or depicted in the Figures may be combined, interchanged, or excluded from other embodiments.

“A system having at least one of A, B, and C” (likewise “a system having at least one of A, B, or C” and “a system having at least one of A, B, C”) includes systems that have A alone, B alone, C alone, A and B together, A and C together, B and C together, and/or A, B, and C together.

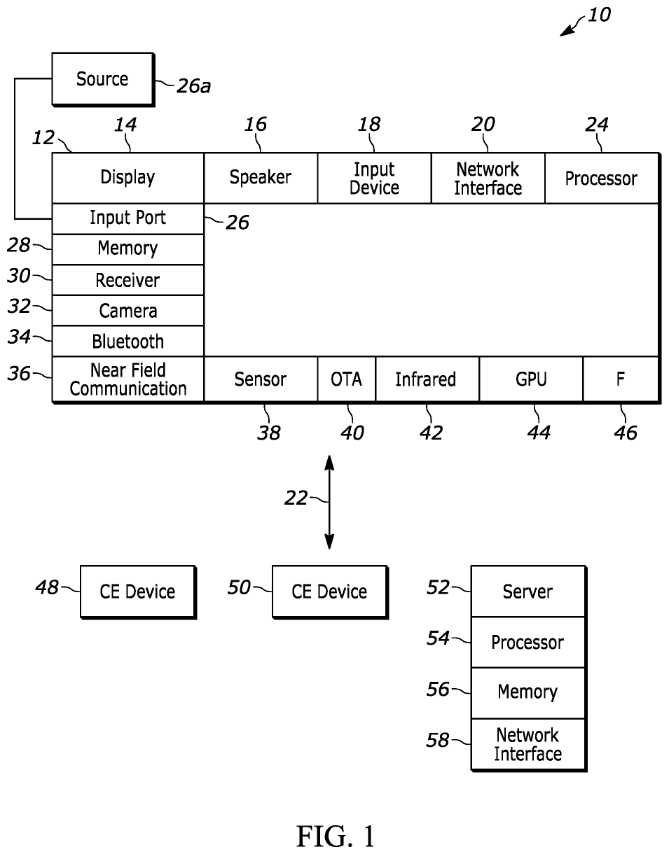

Referring now to FIG. 1, an example system 10 is shown, which may include one or more of the example devices mentioned above and described further below in accordance with present principles. The first of the example devices included in the system 10 is a consumer electronics (CE) device such as an audio video device (AVD) 12 such as but not limited to a theater display system which may be projector-based, or an Internet-enabled TV with a TV tuner (equivalently, set top box controlling a TV). The AVD 12 alternatively may also be a computerized Internet enabled (“smart”) telephone, a tablet computer, a notebook computer, a head-mounted device (HMD) and/or headset such as smart glasses or a VR headset, another wearable computerized device, a computerized Internet-enabled music player, computerized Internet-enabled headphones, a computerized Internet-enabled implantable device such as an implantable skin device, etc. Regardless, it is to be understood that the AVD 12 is configured to undertake present principles (e.g., communicate with other CE devices to undertake present principles, execute the logic described herein, and perform any other functions and/or operations described herein).

Accordingly, to undertake such principles the AVD 12 can be established by some, or all of the components shown. For example, the AVD 12 can include one or more touch-enabled displays 14 that may be implemented by a high definition or ultra-high definition “4K” or higher flat screen. The touch-enabled display(s) 14 may include, for example, a capacitive or resistive touch sensing layer with a grid of electrodes for touch sensing consistent with present principles.

The AVD 12 may also include one or more speakers 16 for outputting audio in accordance with present principles, and at least one additional input device 18 such as an audio receiver/microphone for entering audible commands to the AVD 12 to control the AVD 12. The example AVD 12 may also include one or more network interfaces 20 for communication over at least one network 22 such as the Internet, an WAN, an LAN, etc. under control of one or more processors 24. Thus, the interface 20 may be, without limitation, a Wi-Fi transceiver, which is an example of a wireless computer network interface, such as but not limited to a mesh network transceiver. It is to be understood that the processor 24 controls the AVD 12 to undertake present principles, including the other elements of the AVD 12 described herein such as controlling the display 14 to present images thereon and receiving input therefrom. Furthermore, note the network interface 20 may be a wired or wireless modem or router, or other appropriate interface such as a wireless telephony transceiver, or Wi-Fi transceiver as mentioned above, etc.

In addition to the foregoing, the AVD 12 may also include one or more input and/or output ports 26 such as a high-definition multimedia interface (HDMI) port or a universal serial bus (USB) port to physically connect to another CE device and/or a headphone port to connect headphones to the AVD 12 for presentation of audio from the AVD 12 to a user through the headphones. For example, the input port 26 may be connected via wire or wirelessly to a cable or satellite source 26a of audio video content. Thus, the source 26a may be a separate or integrated set top box, or a satellite receiver. Or the source 26a may be a game console or disk player containing content. The source 26a when implemented as a game console may include some or all of the components described below in relation to the CE device 48.

The AVD 12 may further include one or more computer memories/computer-readable storage mediums 28 such as disk-based or solid-state storage that are not transitory signals, in some cases embodied in the chassis of the AVD as standalone devices or as a personal video recording device (PVR) or video disk player either internal or external to the chassis of the AVD for playing back AV programs or as removable memory media or the below-described server. Also, in some embodiments, the AVD 12 can include a position or location receiver such as but not limited to a cellphone receiver, GPS receiver and/or altimeter 30 that is configured to receive geographic position information from a satellite or cellphone base station and provide the information to the processor 24 and/or determine an altitude at which the AVD 12 is disposed in conjunction with the processor 24. The component 30 may also be implemented by an inertial measurement unit (IMU) that typically includes a combination of accelerometers, gyroscopes, and magnetometers to determine the location and orientation of the AVD 12 in three dimension or by an event-based sensors.

Continuing the description of the AVD 12, in some embodiments the AVD 12 may include one or more cameras 32 that may be a thermal imaging camera, a digital camera such as a webcam, an event-based sensor, and/or a camera integrated into the AVD 12 and controllable by the processor 24 to gather pictures/images and/or video in accordance with present principles. Also included on the AVD 12 may be a Bluetooth® transceiver 34 and other Near Field Communication (NFC) element 36 for communication with other devices using Bluetooth and/or NFC technology, respectively. An example NFC element can be a radio frequency identification (RFID) element.

Further still, the AVD 12 may include one or more auxiliary sensors 38 (e.g., a pressure sensor, a motion sensor such as an accelerometer, gyroscope, cyclometer, or a magnetic sensor, an infrared (IR) sensor, an optical sensor, a speed and/or cadence sensor, an event-based sensor, a gesture sensor (e.g., for sensing gesture command)) that provide input to the processor 24. For example, one or more of the auxiliary sensors 38 may include one or more pressure sensors forming a layer of the touch-enabled display 14 itself and may be, without limitation, piezoelectric pressure sensors, capacitive pressure sensors, piezoresistive strain gauges, optical pressure sensors, electromagnetic pressure sensors, etc.

The AVD 12 may also include an over-the-air TV broadcast port 40 for receiving OTA TV broadcasts providing input to the processor 24. In addition to the foregoing, it is noted that the AVD 12 may also include an infrared (IR) transmitter and/or IR receiver and/or IR transceiver 42 such as an IR data association (IRDA) device. A battery (not shown) may be provided for powering the AVD 12, as may be a kinetic energy harvester that may turn kinetic energy into power to charge the battery and/or power the AVD 12. A graphics processing unit (GPU) 44 and field programmable gated array 46 also may be included. One or more haptics/vibration generators 47 may be provided for generating tactile signals that can be sensed by a person holding or in contact with the device. The haptics generators 47 may thus vibrate all or part of the AVD 12 using an electric motor connected to an off-center and/or off-balanced weight via the motor's rotatable shaft so that the shaft may rotate under control of the motor (which in turn may be controlled by a processor such as the processor 24) to create vibration of various frequencies and/or amplitudes as well as force simulations in various directions.

In addition to the AVD 12, the system 10 may include one or more other CE device types. In one example, a first CE device 48 may be a computer game console that can be used to send computer game audio and video to the AVD 12 via commands sent directly to the AVD 12 and/or through the below-described server while a second CE device 50 may include similar components as the first CE device 48. In the example shown, the second CE device 50 may be configured as a computer game controller manipulated by a player or a head-mounted display (HMD) worn by a player. The HMD may include a heads-up transparent or non-transparent display for respectively presenting AR/MR content or VR content.

In the example shown, only two CE devices are shown, it being understood that fewer or greater devices may be used. A device herein may implement some or all of the components shown for the AVD 12. Any of the components shown in the following figures may incorporate some or all of the components shown in the case of the AVD 12.

Now in reference to the afore-mentioned at least one server 52, it includes at least one server processor 54, at least one tangible computer readable storage medium 56 such as disk-based or solid-state storage, and at least one network interface 58 that, under control of the server processor 54, allows for communication with the other illustrated devices over the network 22, and indeed may facilitate communication between servers and client devices in accordance with present principles. Note that the network interface 58 may be, e.g., a wired or wireless modem or router, Wi-Fi transceiver, or other appropriate interface such as, e.g., a wireless telephony transceiver.

Accordingly, in some embodiments the server 52 may be an Internet server or an entire server “farm” and may include and perform “cloud” functions such that the devices of the system 10 may access a “cloud” environment via the server 52 in example embodiments for, e.g., network gaming applications. Or the server 52 may be implemented by one or more game consoles or other computers in the same room as the other devices shown or nearby.

The components shown in the following figures may include some or all components shown in herein. Any user interfaces (UI) described herein may be consolidated and/or expanded, and UI elements may be mixed and matched between UIs.

Present principles scale the localized multi-player cooperative gaming experience at experience to dozens or even scores of people playing simultaneously, for example in a movie theater.

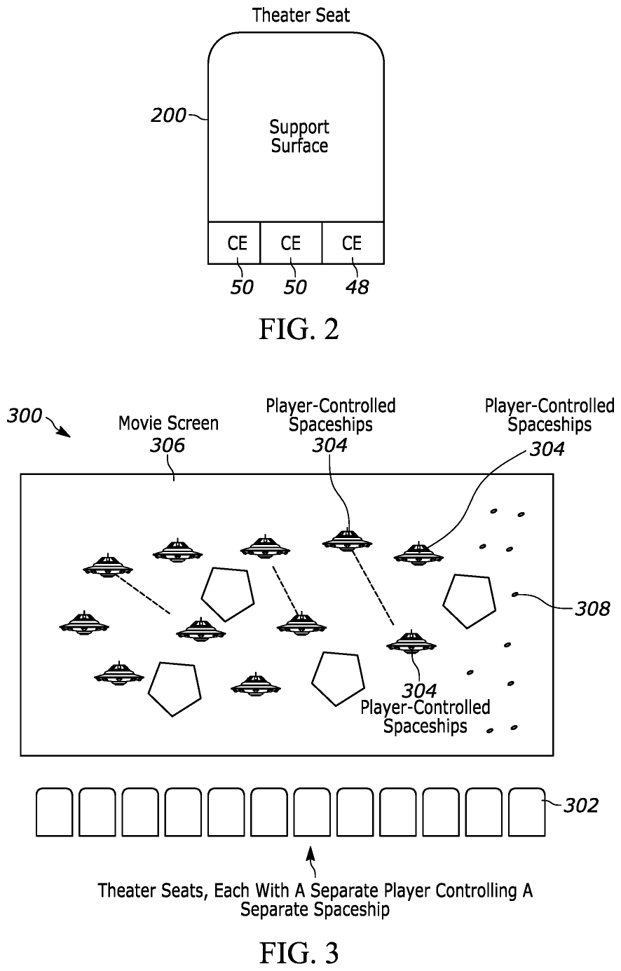

FIG. 2 illustrates that seats 200 in the theater may include (in their person support surfaces 200 or in the case of a headset resting on the seat to be picked up by a player) an instance of the first CE device 48 shown n FIG. 1, implemented in FIG. 2 as a processor-based system such as a computer game console and two or more instances of the second CE device 50, implemented in FIG. 2 by a computer game controller and an augmented reality (AR) headset or three dimensional glasses (collectively, head-mounted displays or HMDs).

Each seat 200 is configured to support a person in a sitting position, including a sitting back or lounging position.

The gameplay takes place on the giant screen at the front of the theater. Each person in a seat 200 may manipulate the computer controller associated with the seat to control one character or avatar (in some implementations, one and only one character or avatar) in a gameplay space that is projected on the screen.

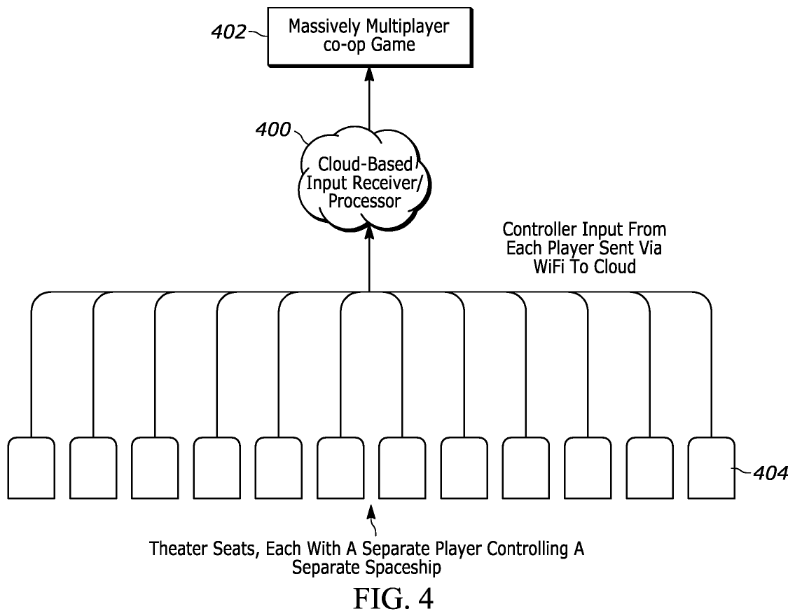

In FIG. 3, in a theater 300 with, e.g., one hundred people in respective seats 302 that may incorporate all of part of the features of the seat 200 shown in FIG. 2, there would be one hundred characters or avatars 304 (collectively, user-controlled game objects) projected onto a large theater screen 306, each controlled by a different player. For example, the game may be a massive battle royale space battle in which each player controls a spaceship in a giant star field 308.

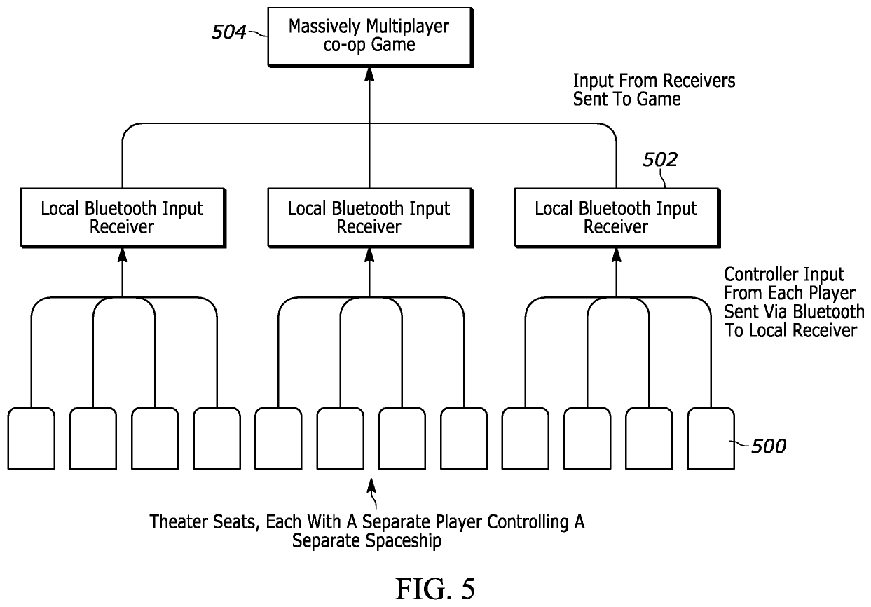

To facilitate the experience illustrated in FIG. 3, a technique is used to pair the controllers (in the example discussed, one hundred controllers) to the same instance of the game is provided. A first example is shown in FIG. 4, in which each controller is wireless (e.g., Wi-Fi enabled) to wirelessly communicate, via the Internet, with at least one cloud gaming server 400 executing a single instance 402 of a computer simulation such as a computer simulation. The server 400 coordinates the input of all of the controllers associated with the theater seats 404, each of which may be implemented by all of part of the seat 200 shown in FIG. 2.

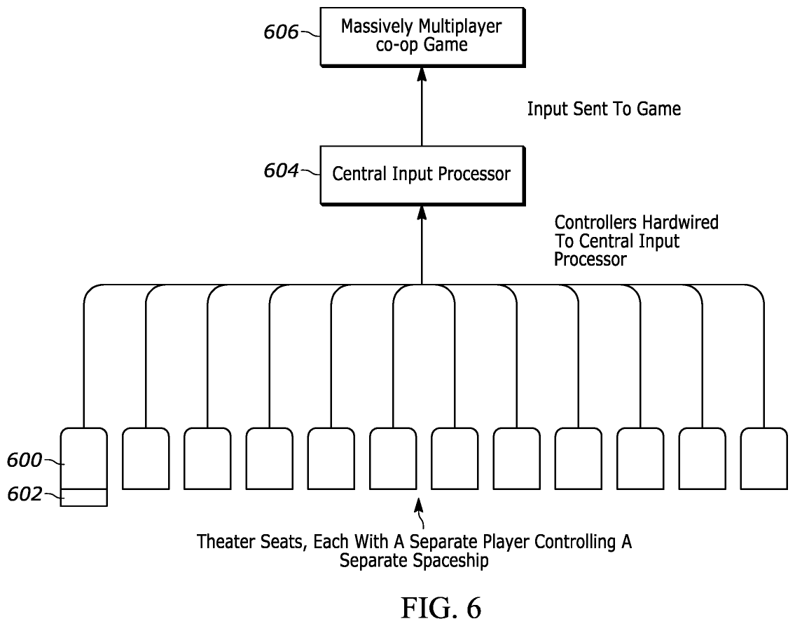

A second technique is illustrated in FIG. 5, in which one or more theater seats 500 each of which may be implemented by all of part of the seat 200 shown in FIG. 2 communicates with a local Bluetooth® or other short-range wireless transceiver 502 in the theater. Each Bluetooth transceiver 502 communicates via Bluetooth with a respective subset of the seats 500. Each Bluetooth transceiver 502 in turn communicates with a simulation computer 504 such as a simulation console executing a single instance of the simulation being shown on the theater screen. The system shown in FIG. 5 is a local networked system (either hardwired and/or wireless, e.g., Wi-Fi) which does not require cloud access.

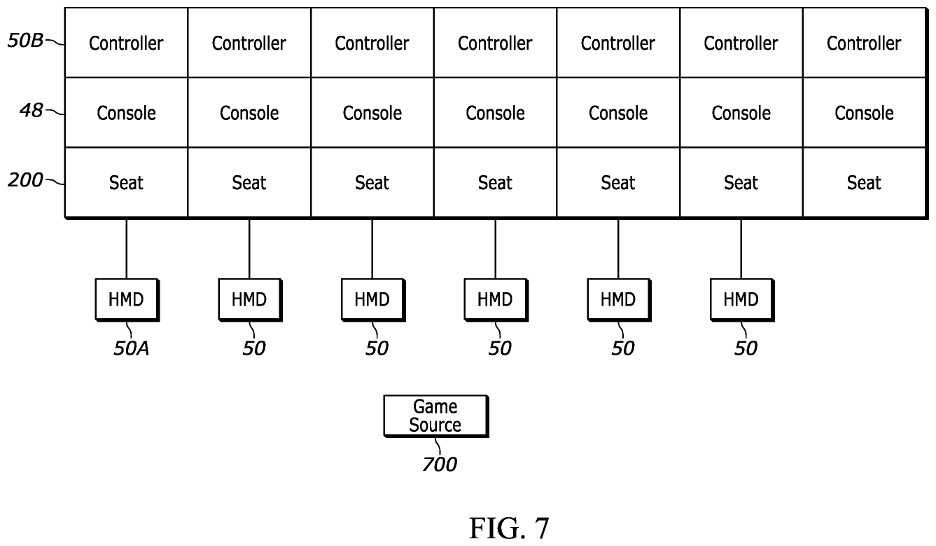

FIG. 6 shows yet another technique in which each seat 600, each of which may be implemented by all of part of the seat 200 shown in FIG. 2, includes a respective controller 602 that may be hardwired to a system connected to the seats or floor of the theater that communicates with a central simulation execution processing system 604 that processes the input from each controller 602 for use in executing a single simulation instance 606.

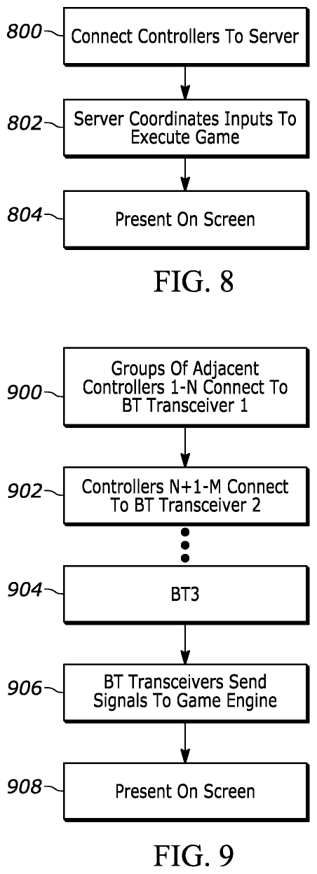

A fourth technique is illustrated in FIG. 7. Each seat 200 includes a respective game execution device such as a computer simulation console 48 such as a computer game console. Associated with each seat 200 is a respective game controller 50B such as a specific purpose controller such as a PlayStation game controller or a general-purpose device such as a user's cell phone that sends game control signals to the console 48 of the respective seat 200. Also associated with each seat is an AR HMD 50A communicating with the console 48 of the associated seat 200.

In FIG. 7, unlike FIGS. 3-6 which show the simulation on a common large theater-type computer screen, the same simulation as provided by a game source 700 such as a local or remote server is rendered in AR on each of the individual AR HMDs 50A associated with each seat 200. Thus, instead of the game being shown on a massive, shared screen, it can be rendered in the volume of the theater, for example overhead. Each HMD 50A may receive simulation control and audio video (AV) data of the simulation from a respective console 48 in the respective seat 200, or the HMD 50A may itself contain the game engine processing circuitry. The gameplay on each headset 50A can be similar as above, with each player controlling a spaceship in a star field. But in this embodiment, the star field is rendered on AR headsets worn by each player over the heads of the players. Each player controls a spaceship in 3D space that is bound by the boundaries of the theater using a respective controller 50B associated with the respective seat 200. In this embodiment, the game executed on each HMD requires an awareness of a player's position in space (what seat they are in) relative to other players, so the AR can be rendered from the appropriate perspective of each individual player. Since each player has a slightly different perspective, concurrent instances of the game may be rendered, one for each player, all synchronized in real time to create a shared experience of a single play area. The instances of the game may be executed on respective individual computer simulation consoles 48 in the theater, or by individual cloud gaming servers, or by a single multi-instance game server in the theater or communicating with the headsets over the Internet.

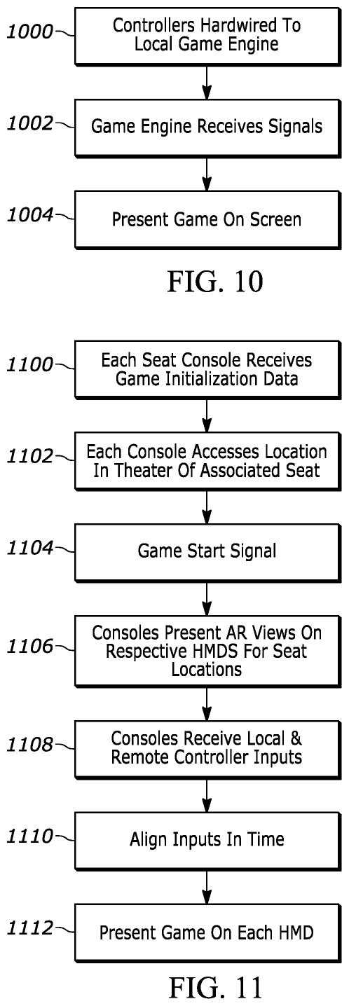

FIGS. 8-11 illustrate example logic in example flow chart format associated with the techniques in FIGS. 4-7, respectively.

Commencing at block 800 in FIG. 8 and with FIG. 4 in mind, all controllers in the theater are connected to a single server or server farm over the Internet. The simulation (e.g., computer game) is started by the server and streamed to the theater screen assembly, which presents the simulation on screen. Player inputs to the controllers are sent to the server, which uses the inputs at block 802 to control movement of the avatar or character (game object) associated with each controller and the theater screen assembly presents the simulation on screen at block 804.

The associations between game objects and controllers may be established pre-game by, e.g., allowing players in sequence to select a game object presented in a list of game objects on screen, with selection associating a controller ID with the selected object. As each player selects an object, the selection signal from the controller, which carries the ID of the controller, is used to tag the selected object, or otherwise associate the selected object with the ID of the selecting controller. Once the game begins, control signals from the controllers including the controller IDs are sent to the server to cause the server to execute the associated object to move or react as dictated by the particular control signals from its controller.

Commencing at block 900 in FIG. 9 and with FIG. 5 in mind, a group of adjacent controllers wirelessly connect to a nearest Bluetooth (BT) transceiver, with a second group of adjacent controllers connecting to a second BT transceiver at block 902 and so on as indicated at block 904, until each group or subset of controllers is connected to a respective BT transceiver. When the game starts, block 906 indicates that each BT transceiver sends received control signals from the respective controllers to the simulation computer 504, which uses the signals to execute the simulation for presentation on screen at block 908. Note that game objects may be correlated with respective controllers according to principles set forth elsewhere herein.

Commencing at block 1000 in FIG. 10 and with FIG. 6 in mind, the controllers associated with each seat may be hardwired to the central processor 604, which receives signals from the controllers at block 1002 and controls the simulation accordingly, which is presented on screen at block 1004.

Commencing at block 1100 in FIG. 11 and with FIG. 7 in mind, each seat console receives game initialization data. The data may be received from, e.g., the game source 700. At block 1102 each console (or other individual rendering unit associated with an individual HMD) accesses the location of its respective seat within the theater. Because the seats typically do not move, this location may be hardcoded into the rendering unit (console) associated with the seat.

Moving to block 1104, a game start signal is received by the individual consoles from, e.g., the source 700, causing each console to present, at block 1106, an instance of the simulation on its respective HMD. All instances on all HMS are identical but for the perspective being presented on each HMD, to account for the location of the respective seat within the theater.

To maintain identity of the instances, at block 1108 as each console receives a control signal from its respective controller, it sends the signals to all other consoles, receiving in turn signals from those consoles input by their respective controllers. The signals are all time-stamped using a common clock such that each console may align all of the control signals in time at block 1110. Each console presents a respective instance of the same simulation (but for a perspective from the location of the associated seat) on its respective HMD at block 1112.

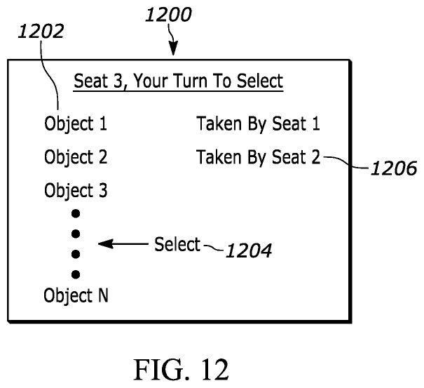

FIG. 12 illustrates an example UI 1200 that may be presented on the theater screen or on each HMD as appropriate to associate game objects with seats by means of associating game objects to the IDs of the respective controllers of each seat. In the example of FIG. 12, the occupants of the first two seats in the theater have selected objects, and it is now the turn of the occupant of the third seat to select an object from a list 1202 of objects using, e.g., the controller up/down and select keys of the respective seat. A select indicator 1204 is presented to alert the occupant what object is currently being pointed to. Advisories 1206 may be presented alerting the occupants of the theater which seats have been associated with which objects. Selection of an object by a controller pairs that object with the controller (using, e.g., controller ID appended to all control signals) during game execution.

While the particular embodiments are herein shown and described in detail, it is to be understood that the subject matter which is encompassed by the present invention is limited only by the claims.

What is claimed is:

1. An assembly, comprising:
plural computer simulation controllers, each associated with a respective seat in a theater, and each correlated to a respective game object in the simulation;
at least one display in the theater configured to present the computer simulation in accordance with signals sent from the plural computer simulation controllers.

2. The assembly of claim 1, wherein each computer simulation controller is associated with one and only one respective game object.

3. The assembly of claim 1, wherein the at least one display comprises a theater screen visible to people sitting in the seats.

4. The assembly of claim 3, comprising at least one server communicating with the computer simulation controllers over a wide area computer network and configured for sending audio video content representing the computer simulation to the at least one display.

5. The assembly of claim 3, comprising:
plural wireless short-range transceivers each configured for communicating with a respective subset of the computer simulation controllers such that a first wireless short-range transceiver can communicate with a first subset of the computer simulation controllers and a second wireless short-range transceiver can communicate with a second subset of the computer simulation controllers; and
at least one server local to the at least one display and receiving signals from the computer simulation controllers through the plural wireless short-range transceivers, the server configured for sending audio video content representing the computer simulation to the at least one display.

6. The assembly of claim 3, comprising at least one server local to the at least one display and connected to the computer simulation controllers by wired paths, the at least one server being configured for sending audio video content representing the computer simulation to the at least one display.

7. The assembly of claim 1, wherein the at least one display comprises plural head-mounted displays (HMD), each HMD being associated with a respective seat.

8. The assembly of claim 7, comprising plural computer simulation computers (CSC) each associated with a respective HMD and a respective computer simulation controller, the CSCs configured for receiving signals from the respective computer simulation controllers and presenting on the respective HMDs the computer simulation consistent with the signals from the computer simulation controllers, the CSCs configured for communicating simulation object control signals to each other and each CSC configured for presenting an instance of the computer simulation on the respective HMD identical to other instances of the computer simulation presented on other HMDs but for each instance being presented from a perspective of the respective seat.

9. The assembly of claim 1, comprising at least one processor programmed with instructions to:
present on the at least one display at least one user interface (UI) comprising UI elements for correlating a respective simulation controller with a respective simulation object.

10. A method, comprising:
presenting a computer game on at least one display in a theater; and
controlling the computer game using signals from plural game controllers each associated with a respective seat in the theater.

11. The method of claim 10, wherein the signals comprise identifications of a game controller sending the signal.

12. The method of claim 10, comprising using signals from each game controller to control a respective game object in the computer game.

13. The method of claim 10, wherein the at least one display comprises a single theater screen in the theater.

14. The method of claim 10, wherein the at least one display comprises plural head-mounted displays (HMD), each HMD being associated with a respective seat.

15. A system comprising:
at least one processor;
at least one display; and
plural computer simulation controllers each associated with a respective seat in a theater and configured for sending signals to the at least one processor to control a computer simulation on the at least one display.

16. The system of claim 15, wherein the at least one processor comprises at least one server communicating with the computer simulation controllers over a wide area computer network and configured for sending audio video content representing the computer simulation to the at least one display.

17. The system of claim 15, comprising:
plural wireless short-range transceivers each configured for communicating with a respective subset of the computer simulation controllers such that a first wireless short-range transceiver can communicate with a first subset of the computer simulation controllers and a second wireless short-range transceiver can communicate with a second subset of the computer simulation controllers; and
at least one server embodying the at least one processor and being local to the at least one display and receiving signals from the computer simulation controllers through the plural wireless short-range transceivers, the server configured for sending audio video content representing the computer simulation to the at least one display.

18. The system of claim 15, wherein the at least one processor is embodied in at least one server local to the at least one display and connected to the computer simulation controllers by wired paths, the at least one server being configured for sending audio video content representing the computer simulation to the at least one display.

19. The system of claim 15, wherein the at least one display comprises plural head-mounted displays (HMD), each HMD being associated with a respective seat.

20. The system of claim 19, comprising plural computer simulation computers (CSC) each associated with a respective HMD and a respective computer simulation controller, the CSCs configured for receiving signals from the respective computer simulation controllers and presenting on the respective HMDs the computer simulation consistent with the signals from the computer simulation controllers, the CSCs communicating simulation object control signals to each other and each CSC configured for presenting an instance of the computer simulation on the respective HMD identical to other instances of the computer simulation presented on other HMDs but for each instance being presented from a perspective of the respective seat.
